(19) United States
(12) Patent Application Publication
(10) Pub. No.: US 2026/0098542 A1
(43) Pub. Date: Apr. 9, 2026

(54) FOIL WITH METALLIC LEADING EDGE

(71) Applicant: Greene, Tweed Technologies, Inc., Wilmington, DE (US)

(72) Inventors: Sébastien Kohler, Belmont-sur-Yverdon (CH); Nicolas Weibel, Echichens (CH); Samuel Stutz, Champvent (CH)

(73) Assignee: Greene, Tweed Technologies, Inc., Wilmington, DE (US)

(21) Appl. No.: 19/351,988

(22) Filed: Oct. 7, 2025

Related U.S. Application Data
(60) Provisional application No. 63/704,878, filed on Oct. 8, 2024.

(51) Int. Cl. F04D 29/02; B29C 70/76; B29L 31/08; F01D 9/04; F04D 29/54

(52) U.S. Cl. CPC F04D 29/023; B29C 70/76; F01D 9/041; F04D 29/542; B29L 2031/08; F05D 2240/121; F05D 2300/10; F05D 2300/603

(57) ABSTRACT

A thermoplastic composite foil and a method of manufacturing a thermoplastic composite foil are described herein. The thermoplastic composite foil may include a first portion and a second portion. The first portion may define a leading edge of the thermoplastic composite foil. The first portion may be metallic such that the leading edge of the thermoplastic composite foil is metallic. The first portion may define a co-molded surface that is surface-treated and configured to abut the second portion. The co-molded surface may extend between a first trailing edge of the first portion and a second trailing edge of the first portion on an opposite side of the first portion than the leading edge. The second portion may define a trailing edge of the thermoplastic composite foil. The second portion may include a thermoplastic composite. The first portion may be co-molded with the second portion within a mold assembly.

### CROSS-REFERENCE TO RELATED APPLICATIONS

This application claims the benefit of U.S. Provisional Application No. 63/704,878 filed on Oct. 8, 2024, the entire contents of which is incorporated herein by reference.

### BACKGROUND

Discontinuous long fibre (DLF) materials have been successfully implemented in the aerospace industry for a number of years to replace complex-shaped metallic components, with their remarkable combination of good chemical and high thermal resistance, high stiffness and creep resistance above the glass transition temperature being deemed very desirable. As the confidence of the aero market in DLF products increases, their application to ever more critical areas of engines and airframes is being considered. Making foils, and especially airfoils out of composites is a well-known design choice to reduce the weight of said foil. This is for instance commonly encountered on Fan blades in current commercial turbofan engines. However, for smaller, most likely non-structural airfoils, there seems to be a case for the use of DLF, especially when attempting to mold an integral foil, where the aerodynamic profile and its retaining sections are molded in a single operation. This often comes with high-velocity impact resistance and erosion resistance requirements for parts present in the air stream, specifically hail impact resistance requirements which may be difficult for a composite (e.g., polymeric composite) airfoil to withstand.

### SUMMARY

A thermoplastic composite foil is described herein. The thermoplastic composite foil may include a first portion and a second portion. The first portion may define a leading edge of the thermoplastic composite foil. The first portion may be metallic such that the leading edge of the thermoplastic composite foil is metallic. The first portion may define a co-molded surface that is surface-treated and configured to abut the second portion. The co-molded surface may extend between a first trailing edge of the first portion and a second trailing edge of the first portion on an opposite side of the first portion than the leading edge. The second portion may define a trailing edge of the thermoplastic composite foil. The second portion may include a thermoplastic composite. The first portion may be co-molded with the second portion within a mold assembly.

A method of manufacturing a thermoplastic composite foil with a metallic leading edge is described herein. A metallic leading edge portion of the thermoplastic composite foil may be provided with a metallic leading edge (e.g., a metallic leading insert). The metallic leading edge portion may be surface treated. The metallic leading edge portion may be placed and/or aligned within a mold assembly. Two or more portions of the mold assembly may be secured with the metallic leading edge portion located within a cavity defined by the two or more portions. A thermoplastic composite may be co-molded with the metallic leading edge portion by introducing the thermoplastic composite into the cavity and applying heat and pressure to the cavity of the mold assembly. The thermoplastic composite foil with the metallic leading edge may be removed from the cavity.

### BRIEF DESCRIPTION OF THE DRAWINGS

FIGS. 1A-1G are perspective and side views of example thermoplastic composite foils with metallic leading edges.

FIGS. 2A-2H are perspective views of an example mold used to produce one or more of the thermoplastic composite foils of FIGS. 1A-1G.

FIG. 3 is a flowchart of an example method of manufacturing a thermoplastic composite foil having a metallic leading edge.

### DETAILED DESCRIPTION

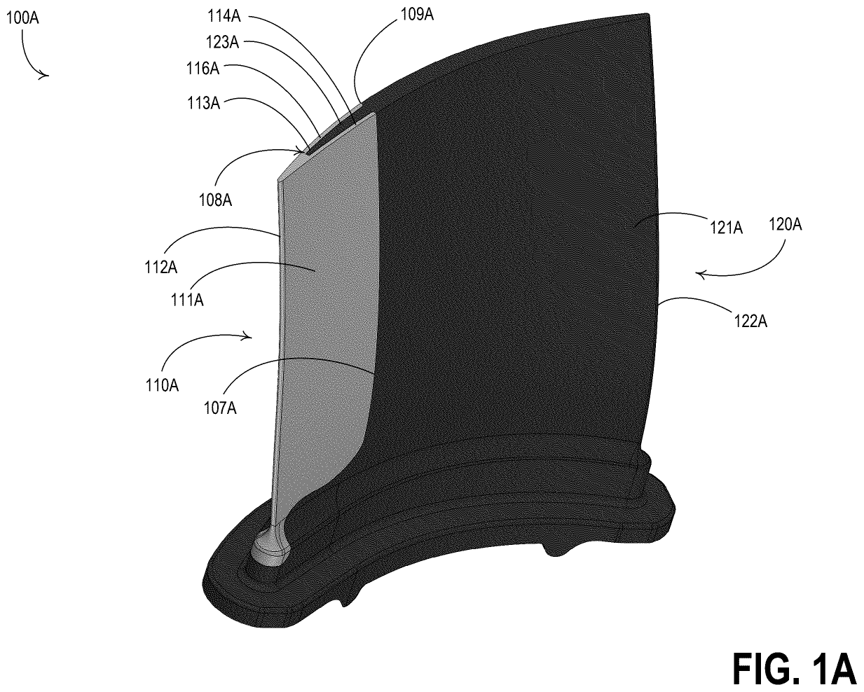

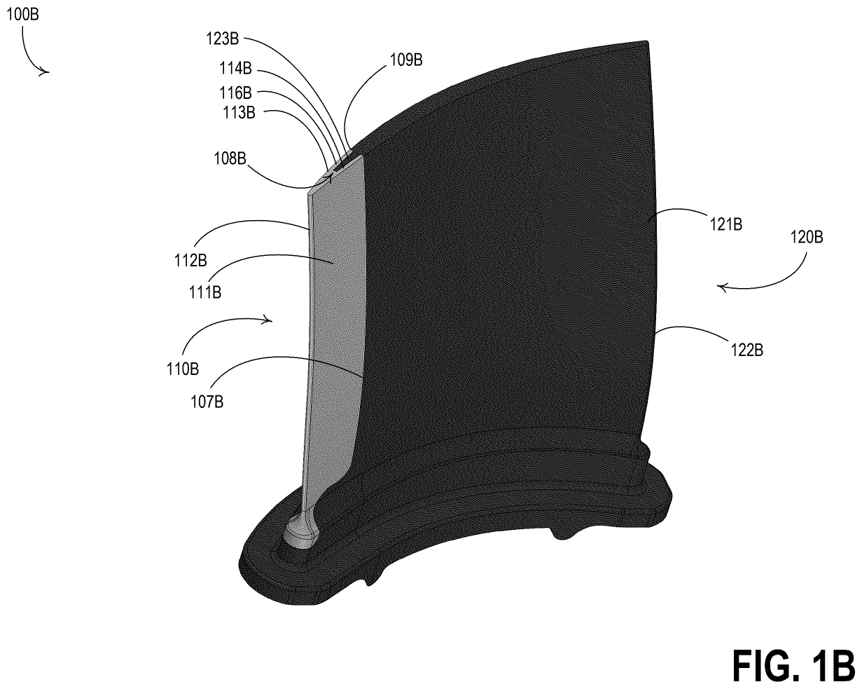

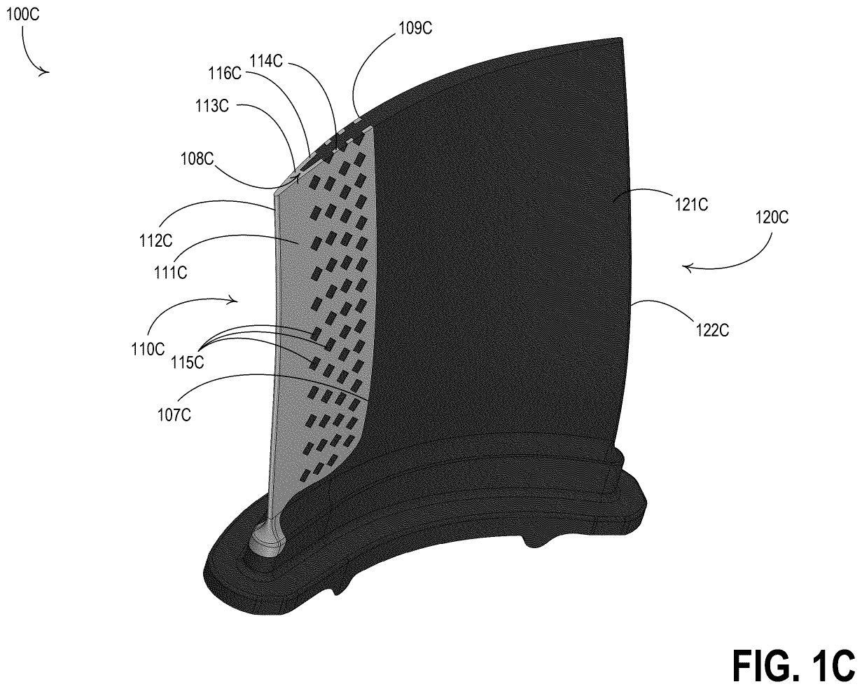

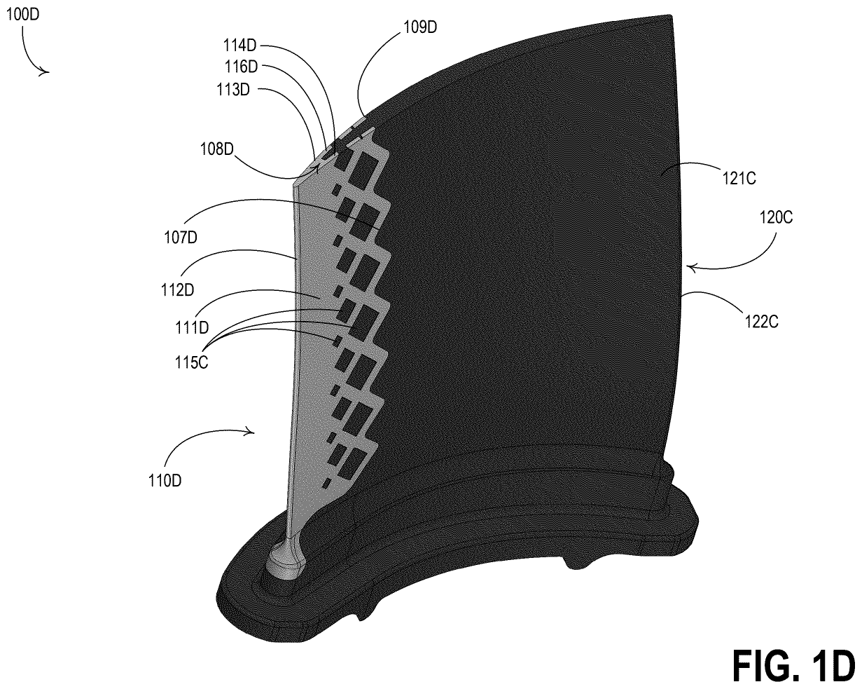

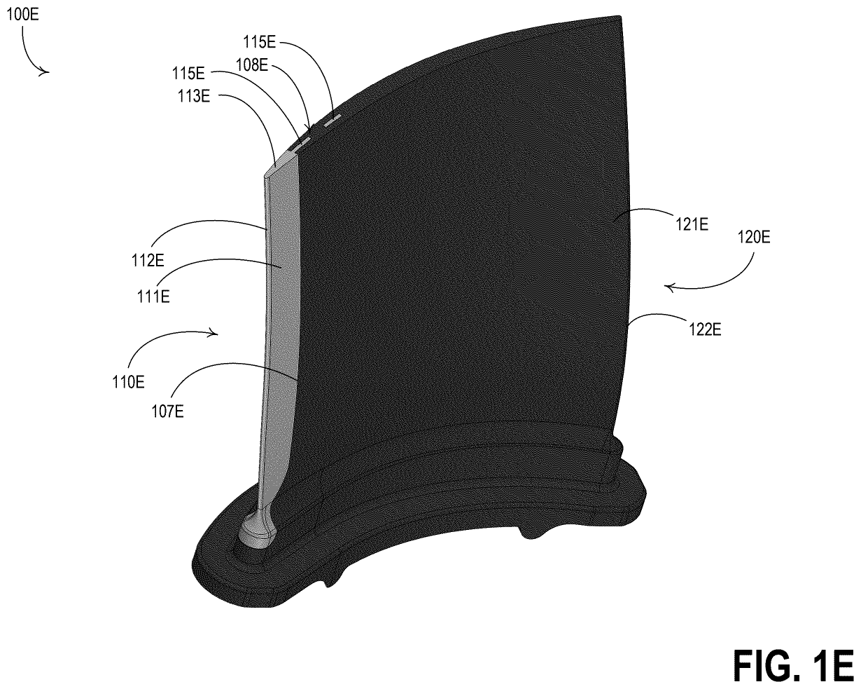

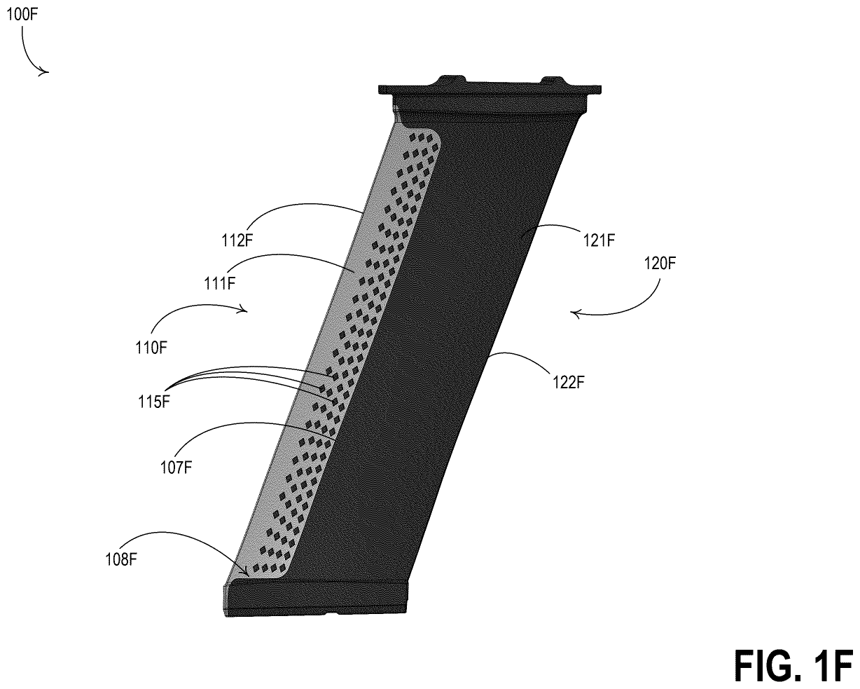

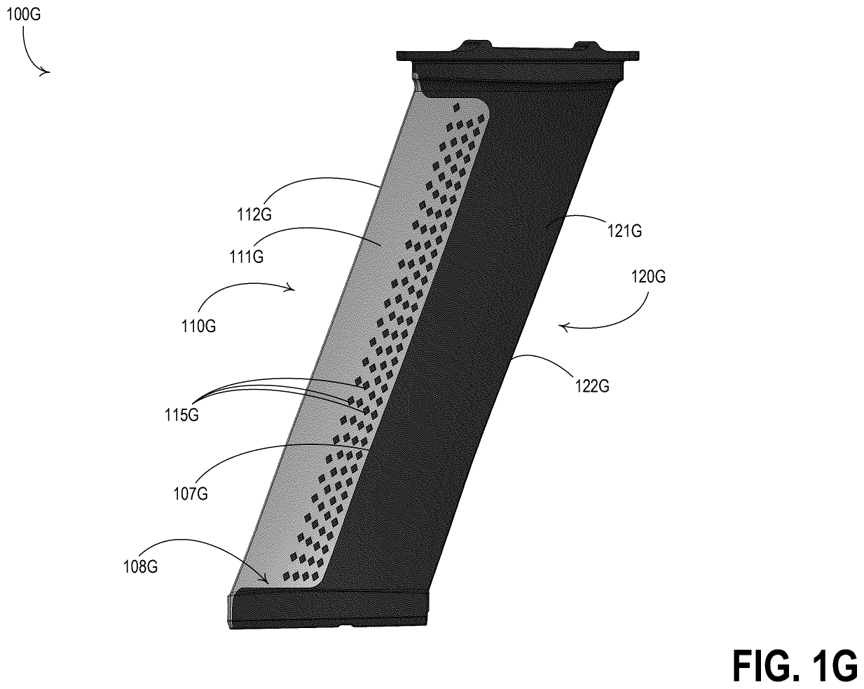

FIGS. 1A-1G are views of example thermoplastic composite foils 100A, 100B, 100C, 100D, 100E, 100F, 100G with metallic leading edges. It should be appreciated that although the figures and the description herein depict airfoils, the disclosed apparatuses and methods are also applicable to hydrofoils. Thermoplastic composites may include materials made from a polymeric matrix polymer material and a reinforcing agent. Preferred matrix polymers for use in the composites herein are preferably polymeric thermoplastics and resins suitable for molding and being loaded or filled with continuous or discontinuous fiber reinforcement as well as those able to accept other fillers as needed. A matrix polymer is at least one thermoplastic polymer that flows under application of heat. Preferred thermoplastic matrix polymers are those selected from the engineering and high-performance polymers.

Exemplary engineering thermoplastics include polybutadiene, polyacrylonitrile (PAN), poly(butadiene-styrene) (PBS), poly(styrene-acrylonitrile) (SAN), fluoropolymers (including melt-processible fluoroplastics (such as copolymers of tetrafluoroethylene (TFE) and at least one perfluoroalkylvinyl ether (PAVE) (PFA), copolymers of TFE and at least one other perfluorinated alkylene (such as hexafluoropropylene) (FEP)), poly(chlorotrifluoroethylene), polyethyl chlorotrifluoroethylene (ECTFE), polyethyltrifluoroethylene (ETFE), polyvinyl fluoride (PVF) and polyvinylidene fluoride (PVDF)), ionomers, liquid crystalline polymer (LCP), polyacetals, polyacrylates, polyamides (such as PA6, PA11, PA12, PPA), polycarbonates (PC), polyolefins such as polyethylene or polypropylene and their copolymers, polyalkylene terephthalates (such as polyethylene terephthalate and polybutylene terephthalate), polyphthalimides, polyimides, polyetheramides, and polyamideimides as well as copolymers or combinations (such as blends or alloys) of such polymers.

Examples of high-performance thermoplastic polymers include, for example polycarbonates, linear aromatic polyesters, linear aromatic polyimides, e.g., polymethacrylimide (PMI), polyamide-imide (PAI), polyether(ether-imide) (PEI), and poly(imide-sulfone) (PISO), polyurethanes, polyphenylene oxides (PPO), polyphenylene ethers, polyphenylene esters, polyphenylene ether esters, polyphenylene sulfides (PPS), polysulfones (PSU), polyether sulfones (PES), polyphenylsulfones (PPSU), polymethylpentenes, polyketones, polyaryl ethers (PAE), such as polyaryl ether sulfone (PES) and polyaryl ether nitrile (PEN), aramids, e.g., poly(p-phenylene terephthalamide) and poly(m-phenylene isophthalamide, and polyaryl ether ketones (PAEK), and other similar PAEs and PAEKs, e.g., polyetherketone (PEK), polyetherketoneketone (PEKK), polyetheretherketone (PEEK), polyetheretherketoneketone (PEEKK), polyetherketoneetherketoneketone (PEKEKK) and similar PAEs. and PAEKs, also copolymers and combinations (such as blends or alloys) of these materials with other polymers may be used.

For less demanding environments, the matrix material may include more standard thermoplastic matrix resins, such as standard thermoplastic polyolefins (such as polyethylene, polybutylene, polypropylene, high-density polyethylene, low density polyethylene), poly(acrylonitrile-butadiene-styrene) (ABS), standard polystyrenes, cellulosic resins (such as ethylcellulose, cellulose acetate, cellulose acetate butyrate, cellulose acetate propionate, and cellulose nitrate), polyethylene vinyl alcohols (EVA), polyvinyl chlorides (PVC), and polyethylene vinyl acetates (PVA).

The matrix material may include one or more thermosetting polymers, for example a thermosetting polymer selected from the group consisting of ethylene propylene diene rubber, ethylenepropylene rubber, thermosetting polyurethane elastomers, epoxy resins, thermosetting biscitraconicimides, bismaleimides (BMI), bismaleimide/triazine/epoxy resins, cyanate esters, cyanate resins, furanic resins, phenolic resins, urea-formaldehyde resins, melamine-formaldehyde resins, phthalocyanine resins, polybenzoxazole resins, acetylene-terminated polyimide resins, silicones, polytriazines, thermosetting polyvinyl esters, thermosetting polyurethanes, polytetrafluoroethylene, melamines, polyalkyds, xylene resins, and combinations and copolymers thereof.

It should be appreciated that the polymers disclosed herein are not exhaustive, and one skilled in the art would understand based on this disclosure that other thermoplastics or thermosetting materials could be used in the apparatuses and/or methods described herein without departing from the scope thereof, provided that they are suitable for forming the composite articles herein.

Co-polymers (polymers formed of two or more monomeric species in random or block form, or graft copolymers, any of which may have multiple monomeric components or reactants) of each or any of the above polymers may also be used within the scope of the invention, whether known or to be developed. In addition, depending on the polymer chosen, the polymers may be derivatized and/or include functional groups (whether terminal and/or on the chain), branched and/or straight chain backbone structures, additional locations of unsaturation along the chain or side groups, and the like. Functional groups which may be provided include aryls, ketones, acetylenes, acid groups, hydroxyl, sulfur-containing groups, sulfates, sulfites, mercapto, phosphato, carboxyl, cyano, phosphite, oxygen/ether or esters (also can be incorporated within the chains or side chains), carboxylic acid, nitric, ammonium, amide, amidine, benzamidine, imidizole, and the like. The selected polymer(s) may also be used in mixtures, blends, alloys or copolymerized with each other or other monomers to form new random, block or graft copolymers.

The composite materials provided herein may include fiber reinforcement. Fiber reinforcement may be used in any length foil. For example, fiber reinforcement may be used when a foil is over 6 mm in length. It should be appreciated that more than one composite may be used and/or blended in forming one or more of the foils described herein.

Examples of suitable reinforcing fiber materials include, for example, without limitation, various reinforcing fibers that are inorganic fibers such as ceramic fibers, glass fibers, graphite fibers, carbon fibers, quartz fibers, alumina fibers, silicon carbide fibers, basalt fibers, boron fibers, aramid fiber, metal fibers, metal alloy fibers, natural fibers, and combinations thereof such as glass/carbon, glass/graphite/carbon, graphite/carbon, and ceramic/glass. Further organic fibers, such as thermoplastic and thermosetting reinforcing fibers may be used, having first fiber materials such as aramid fibers, polybenzoxazole fiber, and the like, which may be used alone or in a blend with glass, metal, ceramic or carbon fibers.

Preferred fiber materials include ceramic, glass, graphite, carbon, and/or plastic (thermoplastic and thermoset) fibers (such as aramid fiber or polybenzoxazole fiber). The fiber and matrix composites may be provided in a variety of forms, including unidirectional tapes, fabrics, mats, filaments, and other long fiber materials, that can then be cut, milled, ground or otherwise reduced in size. In fiber blends or combined fibrous reinforcements, additional fibers may be provided in the form of chopped strands, filaments or whiskers to the fiber matrix prior to impregnation. Further, such blends may include bundles, tows and braids extending in a long fiber direction and/or various woven or blended fibrous materials extending in more than one direction to provide strength and/or other desired properties.

FIG. 1A depicts an example thermoplastic composite foil 100A (e.g., an outlet guide vane of a turbofan engine). The use of “thermoplastic” herein may be regarded as a flow processable polymeric composite. The thermoplastic composite foil 100A may include a first portion 110A that is metallic (e.g., such as titanium, steel, aluminum, inconel, Hastelloy and other nickel alloys, cobalt, bronze, brass, zinc alloys, etc.) and a second portion 120A that comprises a thermoplastic (e.g., such as PEEK). For example, the first portion 110A may define the metallic leading edge of the thermoplastic composite foil 100A. The first portion 110A may be configured to improve the impact resistance and/or erosion resistance of the thermoplastic composite foil 110A. The first portion 110A may be produced via 3D printing, for example, to produce the geometry of the first portion 110A as efficiently as possible while maintaining precise enough geometry at the best possible price. It should be appreciated that production of the first portion 110A is not limited to 3D printing, for example, the first portion 110A may be produced via sintering, machining, casting, forging, stamping, deep drawing, injection, or some other suitable process. The first portion 110A and the second portion 120A may be co-molded together. The first portion 110A may be configured to be placed and aligned within a mold and the thermoplastic may be inserted into the mold, for example, to produce the second portion 120A.

The first portion 110A may define a leading edge 112A of the thermoplastic composite foil 100A. The first portion 110A may also define a first outer wall 114A and a second outer wall 116A. The first portion 110A may define a cavity 113A, for example, between the first outer wall 114A and the second outer wall 116A. The cavity 113A may extend along a length of the first portion 110A. The first portion 110A may define an outer surface 111A and a co-molding surface 108A. The co-molding surface 108A may extend from a first trailing edge 107A of the first portion 110A, across the surfaces on both sides of the cavity 113A, and to a second trailing edge 109A of the first portion 110A. The first outer wall 114A may define the first trailing edge 107A. The second outer wall 116A may define the second trailing edge 109A. The first portion 110A may be 3D printed, for example, to increase adhesion between the first portion 110A and the second portion 120A. The first portion 110A (e.g., at least the co-molding surface 108A) may be pre-treated. The first portion 110A may define a progressive ending (e.g., thickness reduction) proximate to the co-molding surface 108A, for example, to reduce a stiffness mismatch between the first portion 110A and the second portion 120A. Reducing the stiffness mismatch between the first portion 110A and the second portion 120A may reduce stress concentrators at the intersection between the first portion 110A and the second portion 120A (e.g., the first trailing edge 107A, the co-molding surface 108A, and/or the second trailing edge 109A), for example, where cracks may tend to appear.

The second portion 120A may define a trailing edge 122A of the thermoplastic composite foil 100A. The second portion 120A may define an outer surface 121A that is aligned with the outer surface 111A. The second portion 120A may define a tab 123A that is configured to be received within the cavity 113A. For example, the tab 123A may be configured to abut respective inner surfaces of the first outer wall 114A and the second outer wall 116A (e.g., within the cavity 113A).

FIG. 1B depicts an example thermoplastic composite foil 100B (e.g., an outlet guide vane of a turbofan engine). The thermoplastic composite foil 100B may include a first portion 110B that is metallic (e.g., such as titanium, steel, aluminum, inconel, Hastelloy and other nickel alloys, cobalt, bronze, brass, zinc alloys, etc.) and a second portion 120B that comprises a thermoplastic (e.g., such as PEEK). For example, the first portion 110B may define the metallic leading edge of the thermoplastic composite foil 100B. The first portion 110B may be configured to improve the impact resistance and/or erosion resistance of the thermoplastic composite foil 110B. The first portion 110B may be produced via 3D printing, for example, to produce the geometry of the first portion 110B as efficiently as possible while maintaining precise enough geometry at the best possible price. It should be appreciated that production of the first portion 110B is not limited to 3D printing, for example, the first portion 110B may be produced via sintering, machining, casting, forging, stamping, deep drawing, injection, or some other suitable process. The first portion 110B and the second portion 120B may be co-molded together. The first portion 110B and the second portion 120B may be co-molded together. The first portion 110B may be configured to be placed and aligned within a mold and the thermoplastic may be inserted into the mold, for example, to produce the second portion 120B.

The first portion 110B may define a leading edge 112B of the thermoplastic composite foil 100B. The first portion 110B may also define a first outer wall 114B and a second outer wall 116B. The first portion 110B may define a cavity 113B, for example, between the first outer wall 114B and the second outer wall 116B. The cavity 113B may extend along a length of the first portion 110B. The first portion 110B may define an outer surface 111B and a co-molding surface 108B. The co-molding surface 108B may extend from a first trailing edge 107B of the first portion 110B, across the surfaces on both sides of the cavity 113B, and to a second trailing edge 109B of the first portion 110B. The first outer wall 114B may define the first trailing edge 107B.

The second outer wall 116B may define the second trailing edge 109B. The first portion 110B may be 3D printed, for example, to increase adhesion between the first portion 110B and the second portion 120B. The first portion 110B (e.g., at least the co-molding surface 108B) may be pre-treated. The first portion 110B may define a progressive ending (e.g., thickness reduction) proximate to the co-molding surface 108B, for example, to reduce a stiffness mismatch between the first portion 110B and the second portion 120B. Reducing the stiffness mismatch between the first portion 110B and the second portion 120B may reduce stress concentrators at the intersection between the first portion 110B and the second portion 120B (e.g., the first trailing edge 107B, the co-molding surface 108B, and the second trailing edge 109B), for example, where cracks may tend to appear.

The second portion 120B may define a trailing edge 122B of the thermoplastic composite foil 100B. The second portion 120B may define an outer surface 121B that is aligned with the outer surface 111B. The second portion 120B may define a tab 123B that is configured to be received within the cavity 113B. For example, the tab 123B may be configured to abut respective inner surfaces of the first outer wall 114B and the second outer wall 116B (e.g., within the cavity 113B). The second portion 120B may be a larger percentage of the thermoplastic composite foil 100B than the second portion 120A is of thermoplastic composite foil 100B.

FIG. 1C depicts an example thermoplastic composite foil 100C (e.g., an outlet guide vane of a turbofan engine). The thermoplastic composite foil 100C may include a first portion 110C that is metallic (e.g., such as titanium, steel, aluminum, inconel, Hastelloy and other nickel alloys, cobalt, bronze, brass, zinc alloys, etc.) and a second portion 120C that comprises a thermoplastic (e.g., such as PEEK). For example, the first portion 110C may define the metallic leading edge of the thermoplastic composite foil 100C. The first portion 110C may be configured to improve the impact resistance and/or erosion resistance of the thermoplastic composite foil 110C. The first portion 110C may be produced via 3D printing, for example, to produce the geometry of the first portion 110C as efficiently as possible while maintaining precise enough geometry at the best possible price. It should be appreciated that production of the first portion 110C is not limited to 3D printing, for example, the first portion 110C may be produced via sintering, machining, casting, forging, stamping, deep drawing, injection, or some other suitable process. The first portion 110C and the second portion 120C may be co-molded together. The first portion 110C may be configured to be placed and aligned within a mold and the thermoplastic may be inserted into the mold, for example, to produce the second portion 120C.

The first portion 110C may define a leading edge 112C of the thermoplastic composite foil 100C. The first portion 110C may also define a first outer wall 114C and a second outer wall 116C. The first portion 110C may define a cavity 113C, for example, between the first outer wall 114C and the second outer wall 116C. The cavity 113B may extend along a length of the first portion 110C. The first portion 110C may define an outer surface 111C and a co-molding surface 108C. The co-molding surface 108C may extend from a first trailing edge 107C of the first portion 110C, across the surfaces on both sides of the cavity 113C, and to a second trailing edge 109C of the first portion 110C. The first portion 110C may be 3D printed, for example, to increase adhesion between the first portion 110C and the second portion 120C. The first portion 110C (e.g., at least the co-molding surface 108C) may be pre-treated. The first portion 110C may define a progressive ending (e.g., thickness reduction) proximate to the co-molding surface 108C, for example, to reduce a stiffness mismatch between the first portion 110C and the second portion 120C. Reducing the stiffness mismatch between the first portion 110C and the second portion 120C may reduce stress concentrators at the intersection between the first portion 110C and the second portion 120C (e.g., the first trailing edge 107C, the co-molding surface 108C, and/or the second trailing edge 109C), for example, where cracks may tend to appear.

The first portion 110C may define a plurality of openings 115C. The plurality of openings 115C may extend through the first outer wall 114C and/or the second outer wall 116C. For example, each of the plurality of openings 115C may extend from the outer surface 111C and through a respective one of the first outer wall 114C and the second outer wall 116C. It should be appreciated that although the openings 115C are shown extending through the first outer wall 114C and the second outer wall 116C, the openings 115C may instead extend partially through the first portion 110C (e.g., and define dimples on the first outer wall 114C and/or the second outer wall 116C). The openings 115C may become increasingly dense through the first portion 110C the closer the respective one of the openings 115C is to the first trailing edge 107C or the second trailing edge 109C of the first portion 110C, for example, to enable a stiffness reduction at the intersection between the first portion 110C and the second portion 120C (e.g., the co-molding surface 108C).

For example, the openings 115C may be closer together (e.g., more dense) proximate to the first trailing edge 107C and the second trailing edge 109C than they are distal from the first trailing edge 107C and the second trailing edge 109C. The openings 115C may be polygonal shaped (e.g., diamond-shaped). The openings 115C (e.g., the second portion 120C extending into the openings 115C) may be configured to add mechanical interlocking between the first portion 110C and the second portion 120C (e.g., at least partially interlock the first portion 110C and the second portion 120C). For example, the first portion 110C and the second portion 120C may be interlocked by the second portion 120C extending into the openings 115C.

The second portion 120C may define a trailing edge 122C of the thermoplastic composite foil 100C. The second portion 120C may define an outer surface 121C that is aligned with the outer surface 111C. The second portion 120C may define a tab 123C that is configured to be received within the cavity 113C. For example, the tab 123C may be configured to abut respective inner surfaces of the first outer wall 114C and the second outer wall 116C (e.g., within the cavity 113C). The second portion 120C may extend into the plurality of openings 109C in the first portion 110C.

FIG. 1D depicts an example thermoplastic composite foil 100D (e.g., an outlet guide vane of a turbofan engine). The thermoplastic composite foil 100D may include a first portion 110D that is metallic (e.g., such as titanium, steel, aluminum, inconel, Hastelloy and other nickel alloys, cobalt, bronze, brass, zinc alloys, etc.) and a second portion 120D that comprises a thermoplastic (e.g., such as PEEK). For example, the first portion 110D may define the metallic leading edge of the thermoplastic composite foil 100D. The first portion 110D may be configured to improve the impact resistance and/or erosion resistance of the thermoplastic composite foil 110D. The first portion 110D may be produced via 3D printing, for example, to produce the geometry of the first portion 110D as efficiently as possible while maintaining precise enough geometry at the best possible price. It should be appreciated that production of the first portion 110D is not limited to 3D printing, for example, the first portion 110D may be produced via sintering, machining, casting, forging, stamping, deep drawing, injection, or some other suitable process. The first portion 110D and the second portion 120D may be co-molded together. The first portion 110D may be configured to be placed and aligned within a mold and the thermoplastic may be inserted into the mold, for example, to produce the second portion 120D.

The first portion 110D may define a leading edge 112D of the thermoplastic composite foil 100D. The first portion 110D may also define a first outer wall 114D and a second outer wall 116D. The first portion 110D may define a cavity 113D, for example, between the first outer wall 114D and the second outer wall 116D. The cavity 113D may extend along a length of the first portion 110D. The first portion 110D may define an outer surface 111D and a co-molding surface 108D. The co-molding surface 108D may extend from a first trailing edge 107D of the first portion 110D, across the surfaces on both sides of the cavity 113D, and to a second trailing edge 109D of the first portion 110D. The first portion 110D may be 3D printed, for example, to increase adhesion between the first portion 110D and the second portion 120D. The first portion 110D (e.g., at least the co-molding surface 108D) may be pre-treated. The first portion 110D may define a progressive ending (e.g., thickness reduction) proximate to the co-molding surface 108D, for example, to reduce a stiffness mismatch between the first portion 110D and the second portion 120D. Reducing the stiffness mismatch between the first portion 110D and the second portion 120D may reduce stress concentrators at the intersection between the first portion 110D and the second portion 120D (e.g., the first trailing edge 107D, the co-molding surface 108D, and/or the second trailing edge 109D), for example, where cracks may tend to appear.

The first portion 110D may define a plurality of openings 115D. The plurality of openings 115D may extend through the first outer wall 114D and/or the second outer wall 116D. or example, each of the plurality of openings 115D may extend from the outer surface 111D and through a respective one of the first outer wall 114D and the second outer wall 116D. It should be appreciated that although the openings 115D are shown extending through the first outer wall 114D and the second outer wall 116D, the openings 115D may instead extend partially through the first portion 110D (e.g., and define dimples on the first outer wall 114D and/or the second outer wall 116D). The first trailing edge 107D and/or the second trailing edge 109D of the first portion 110D may not be smooth. The first trailing edge 107D and the second trailing edge 109D may be non-linear (e.g., wavy or jagged). For example, the first trailing edge 107D and/or the second trailing edge 109D may define a non-linear (e.g., wavy and/or jagged shaped) edge that is associated with the plurality of openings 115D. For example, a subset of the plurality of the openings 115D may define the first trailing edge 107D and/or the second trailing edge 109D such that at least a portion of the subset of the plurality of openings 115D defines the non-smooth edge. The openings 115D may become increasingly dense through the first portion 110D the closer the respective one of the openings 115D is to the first trailing edge 107D and/or the second trailing edge 109D of the first portion 110D, for example, to enable a stiffness reduction at the intersection between the first portion 110D and the second portion 120D (e.g., the co-molding surface 108D). For example, the openings 115D may be closer together (e.g., more dense) proximate to the first trailing edge 107D and the second trailing edge 109D than they are distal from the first trailing edge 107D and the second trailing edge 109D. The openings 115D may be polygonal shaped (e.g., diamond-shaped). The plurality of openings 115D may increase in size toward the first trailing edge 107D and the second trailing edge 109D. The openings 115D (e.g., the second portion 120D extending into the openings 115D) may be configured to add mechanical interlocking between the first portion 110D and the second portion 120D (e.g., at least partially interlock the first portion 110D and the second portion 120D). For example, the first portion 110D and the second portion 120D may be interlocked by the second portion 120D extending into the openings 115D.

The second portion 120D may define a trailing edge 122D of the thermoplastic composite foil 100C. The second portion 120D may define an outer surface 121D that is aligned with the outer surface 111D. The second portion 120D may define a tab 123D that is configured to be received within the cavity 113D. For example, the tab 123D may be configured to abut respective inner surfaces of the first outer wall 114D and the second outer wall 116D (e.g., within the cavity 113D). The second portion 120D may extend into the plurality of openings 109D in the first portion 110D.

FIG. 1E depicts an example thermoplastic composite foil 100E (e.g., an outlet guide vane of a turbofan engine). The thermoplastic composite foil 100E may include a first portion 110E that is metallic (e.g., such as titanium, steel, aluminum, inconel, Hastelloy and other nickel alloys, cobalt, bronze, brass, zinc alloys, etc.) and a second portion 120E that comprises a thermoplastic (e.g., such as PEEK). For example, the first portion 110E may define the metallic leading edge of the thermoplastic composite foil 100E. The first portion 110E may be configured to improve the impact resistance and/or erosion resistance of the thermoplastic composite foil 110E. The first portion 110E may be produced via 3D printing, for example, to produce the geometry of the first portion 110E as efficiently as possible while maintaining precise enough geometry at the best possible price. It should be appreciated that production of the first portion 110E is not limited to 3D printing, for example, the first portion 110E may be produced via sintering, machining, casting, forging, stamping, deep drawing, injection, or some other suitable process. The first portion 110E and the second portion 120E may be co-molded together. The first portion 110E may be configured to be placed and aligned within a mold and the thermoplastic may be inserted into the mold, for example, to produce the second portion 120E.

The first portion 110E may define a leading edge 112E of the thermoplastic composite foil 100E. The first portion 110E may define an outer surface 111E and a co-molding surface 108E. The first portion 110E may also define a tab 115E. The tab 115E may define a portion that defines a reduced thickness (e.g., cross-section area). The tab 115E may extend along a length of the first portion 110E. The tab 115E may be configured to increase the surface area between the first portion 110E and the second portion 110F. The co-molding surface 108E may extend from a first trailing edge 107E of the first portion 110E, across the surfaces on both sides of the tab 115E, and to a second trailing edge 109E of the first portion 110E. The first portion 110E may be 3D printed, for example, to increase adhesion between the first portion 110E and the second portion 120E. The first portion 110E (e.g., at least the co-molding surface 108E) may be pre-treated. Although not shown in the drawings, it should be appreciated that the first portion 110E may define pins extending outward/on top of the co-molding surface 108E, for example, from the tab 115E extending partway through the chord length. The pins may be located in a plurality of discreet locations, for example, in order to locate the tab 115E precisely at the center of the cavity.

The second portion 120E may define a trailing edge 122E of the thermoplastic composite foil 100E. The second portion 120E may define an outer surface 121E that is aligned with the outer surface 111E. The second portion 120E may be located on opposed sides of the tab 115E. The second portion 120E may be a larger percentage of the thermoplastic composite foil 100E than the second portion 120A is of the thermoplastic composite foil 100A and/or than the second portion 120B is of the thermoplastic composite foil 100B.

FIG. 1F is a side view of another example thermoplastic composite foil 100F (e.g., an outlet guide vane of a turbofan engine). The thermoplastic composite foil 100F may include a first portion 110F that is metallic (e.g., such as titanium, steel, aluminum, inconel, Hastelloy and other nickel alloys, cobalt, bronze, brass, zinc alloys, etc.) and a second portion 120F that comprises a thermoplastic (e.g., such as PEEK). For example, the first portion 110F may define the metallic leading edge of the thermoplastic composite foil 100F. The first portion 110F may be configured to improve the impact resistance and/or erosion resistance of the thermoplastic composite foil 110F.

The first portion 110F may be produced via 3D printing, for example, to produce the geometry of the first portion 110F as efficiently as possible while maintaining precise enough geometry at the best possible price. It should be appreciated that production of the first portion 110A is not limited to 3D printing, for example, the first portion 110A may be produced via sintering, machining, casting, forging, stamping, deep drawing, injection, or some other suitable process. The first portion 110F and the second portion 120F may be co-molded together. The first portion 110F may be configured to be placed and aligned within a mold and the thermoplastic may be inserted into the mold, for example, to produce the second portion 120F.

The first portion 110F may define a leading edge 112F of the thermoplastic composite foil 100F. The first portion 110F may also define a first outer wall (e.g., such as the first outer wall 114B shown in FIG. 1B) and a second outer wall (e.g., such as the second outer wall 116B shown in FIG. 1B). The first portion 110F may define a cavity (e.g., such as the cavity 113B shown in FIG. 1B), for example, between the first outer wall and the second outer wall. The cavity may extend along a length of the first portion 110F. The co-molding surface 108F may extend from a first trailing edge 107F of the first portion 110F, across the surfaces on both sides of the cavity, and to a second trailing edge (e.g., such as the second trailing edge 109B shown in FIG. 1B) of the first portion 110F. The first portion 110F may define an outer surface 111F and a co-molding surface 108F. The first portion 110F may be 3D printed, for example, to increase adhesion between the first portion 110F and the second portion 120F. The first portion 110F (e.g., at least the co-molding surface 108F) may be pre-treated. The first portion 110F may define a progressive ending (e.g., thickness reduction) proximate to first trailing edge 107F or the second trailing edge, for example, to reduce a stiffness mismatch between the first portion 110F and the second portion 120F. Reducing the stiffness mismatch between the first portion 110F and the second portion 120F may reduce stress concentrators at the intersection between the first portion 110F and the second portion 120F (e.g., the first trailing edge 107F, the co-molding surface 108F, and/or the second trailing edge), for example, where cracks may tend to appear.

The first portion 110F may define a plurality of openings 115F. The plurality of openings 115F may extend through the first outer wall and/or the second outer wall. For example, each of the plurality of openings 115F may extend from the outer surface 111C and through a respective one of the first outer wall and the second outer wall. It should be appreciated that although the openings 115F are shown extending through the first outer wall and the second outer wall, the openings 115F may instead extend partially through the first portion 110F (e.g., and define dimples on the first outer wall and/or the second outer wall). The openings 115F may become increasingly dense through the first portion 110F the closer the respective one of the openings 115F is to the first trailing edge 107F or the second trailing edge of the first portion 110F, for example, to enable a stiffness reduction at the intersection between the first portion 110F and the second portion 120F (e.g., the co-molding surface 108F). For example, the openings 115F may be closer together (e.g., more dense) proximate to the first trailing edge 107F and the second trailing edge than they are distal from the first trailing edge 107F and the second trailing edge 109. The openings 115F may be polygonal shaped (e.g., diamond-shaped). The openings 115F may be configured to add mechanical interlocking between the first portion 110F and the second portion 120F (e.g., at least partially interlock the first portion 110F and the second portion 120F). For example, the first portion 110F and the second portion 120F may be interlocked by the second portion 120F extending into the openings 115F.

The second portion 120F may define a trailing edge 122F of the thermoplastic composite foil 100F. The second portion 120F may define an outer surface 121F that is aligned with the outer surface 111F. The second portion 120F may define a tab (e.g., such as the tab 123B shown in FIG. 1B) that is configured to be received within the cavity.

FIG. 1G depicts an example thermoplastic composite foil 100G (e.g., an outlet guide vane of a turbofan engine). The thermoplastic composite foil 100G may include a first portion 110G that is metallic (e.g., such as titanium, steel, aluminum, inconel, Hastelloy and other nickel alloys, cobalt, bronze, brass, zinc alloys, etc.) and a second portion 120G that comprises a thermoplastic (e.g., such as PEEK). For example, the first portion 110G may define the metallic leading edge of the thermoplastic composite foil 100G. The first portion 110G may be configured to improve the impact resistance and/or erosion resistance of the thermoplastic composite foil 110G. The first portion 110G may be produced via 3D printing, for example, to produce the geometry of the first portion 110G as efficiently as possible while maintaining precise enough geometry at the best possible price. It should be appreciated that production of the first portion 110G is not limited to 3D printing, for example, the first portion 110G may be produced via sintering, machining, casting, forging, stamping, deep drawing, injection, or some other suitable process. The first portion 110G and the second portion 20G may be co-molded together. The first portion 110G may be configured to be placed and aligned within a mold and the thermoplastic may be inserted into the mold, for example, to produce the second portion 120G.

The first portion 110G may define a leading edge 112G of the thermoplastic composite foil 100G. The first portion 110G may also define a first outer wall (e.g. such as the first outer wall 114B shown in FIG. 1B) and a second outer wall (e.g., such as the second outer wall 116B shown in FIG. 1B). The first portion 110G may define a cavity (e.g., such as the cavity 113B shown in FIG. 1B), for example, between the first outer wall and the second outer wall. The cavity 113G may extend along a length of the first portion 110G. The first portion 110G may define an outer surface 111G and a co-molding surface 108G. The co-molding surface 108G may extend from a first trailing edge 107G of the first portion 110G, across the surfaces on both sides of the cavity, and to a second trailing edge (e.g., such as the second trailing edge 109B shown in FIG. 1B) of the first portion 110G. The first portion 110G may be 3D printed, for example, to increase adhesion between the first portion 110G and the second portion 120G. The first portion 110G (e.g., at least the co-molding surface 108B) may be pre-treated. The first portion 110G may define a progressive ending (e.g., thickness reduction) proximate to the first trailing edge 107G or the second trailing edge, for example, to reduce a stiffness mismatch between the first portion 110G and the second portion 120G. Reducing the stiffness mismatch between the first portion 110G and the second portion 120G may reduce stress concentrators at the intersection between the first portion 110G and the second portion 120G (e.g., the first trailing edge 107G, the co-molding surface 108G, and/or the second trailing edge), for example, where cracks may tend to appear.

The first portion 110G may define a plurality of openings 115G. The plurality of openings 15G may extend through the first outer wall and/or the second outer wall. For example, each of the plurality of openings 115G may extend from the outer surface 111G and through a respective one of the first outer wall and the second outer wall. It should be appreciated that although the openings 115G are shown extending through the first outer wall and the second outer wall, the openings 115G may instead extend partially through the first portion 110G (e.g., and define dimples on the first outer wall and/or the second outer wall). The openings 115G may become increasingly dense through the first portion 110G the closer the respective one of the openings 115G is to the co-molding surface 108G of the first portion 110G, for example, to enable a stiffness reduction at the intersection between the first portion 110G and the second portion 120G (e.g., the co-molding surface 108G). For example, the openings 115G may be closer together (e.g., more dense) proximate to the first trailing edge 107 and the second trailing edge than they are distal from the first trailing edge 107G and the second trailing edge. The openings 115G may be polygonal shaped (e.g., diamond-shaped). The openings 115G may be configured to add mechanical interlocking between the first portion 110G and the second portion 120G (e.g., at least partially interlock the first portion 110G and the second portion 120G). For example, the first portion 110G and the second portion 120G may be interlocked by the second portion 120G extending into the openings 115G.

The second portion 120G may define a trailing edge 122G of the thermoplastic composite foil 100G. The second portion 120B may define an outer surface 121B that is aligned with the outer surface 111B. The second portion 120B may define a tab 123B that is configured to be received within the cavity 113B. The second portion 120B may be a larger percentage of the thermoplastic composite foil 100B than the second portion 120A is of thermoplastic composite foil 100B.

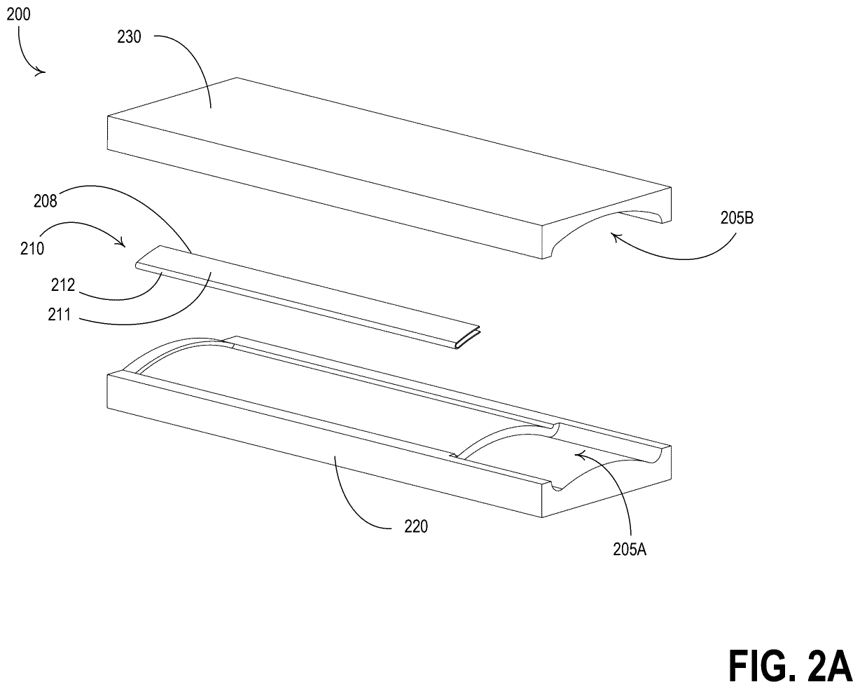

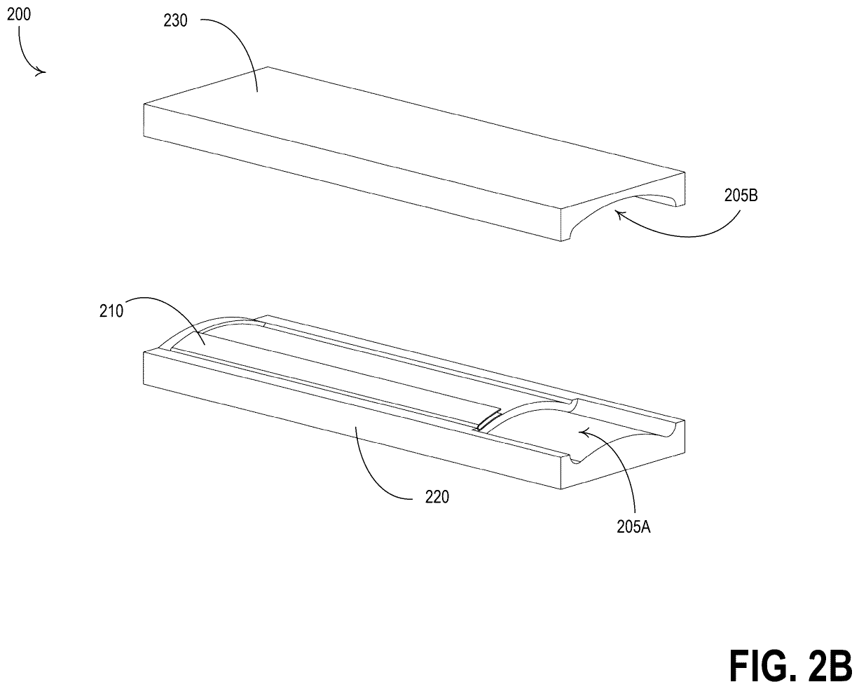

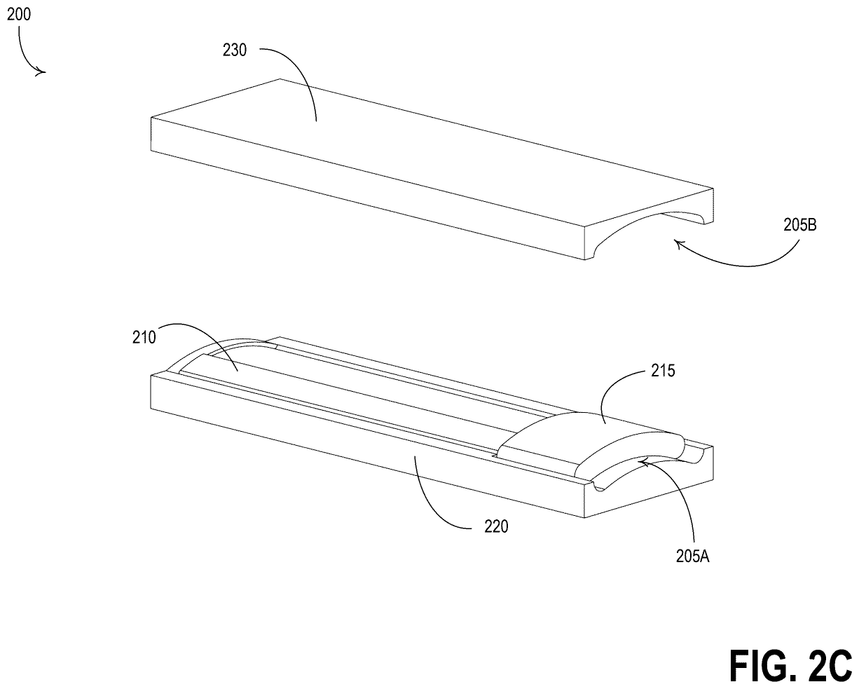

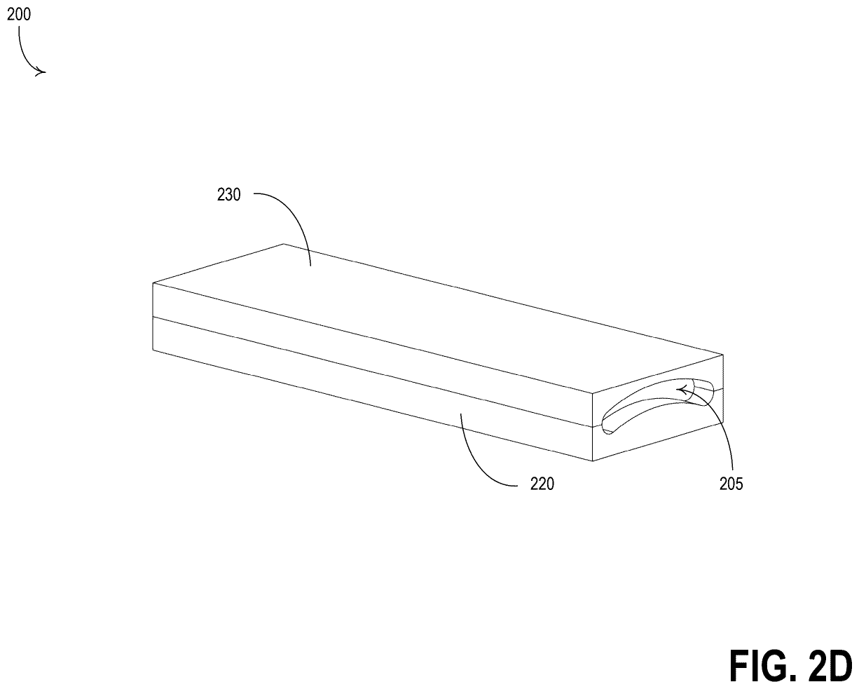

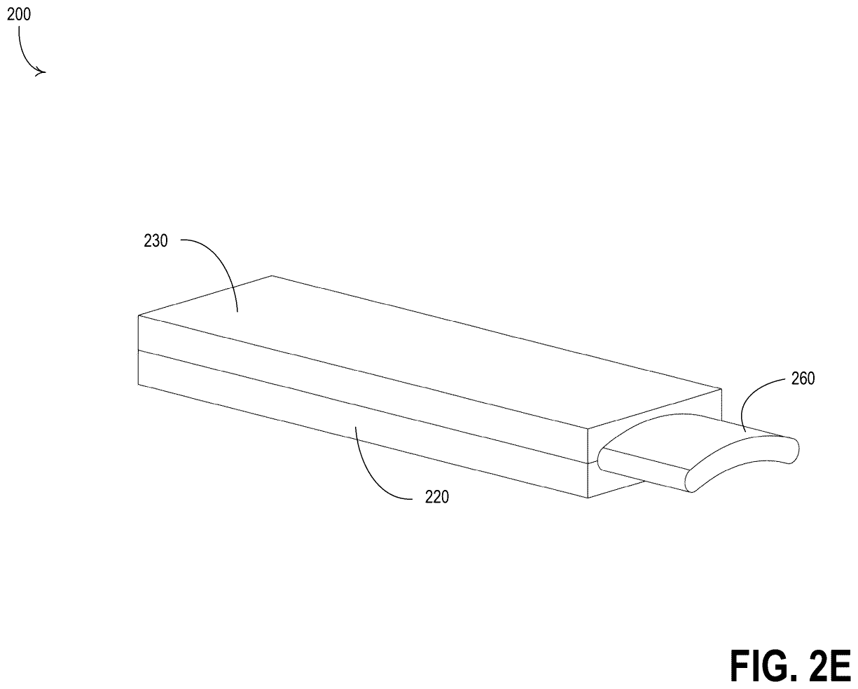

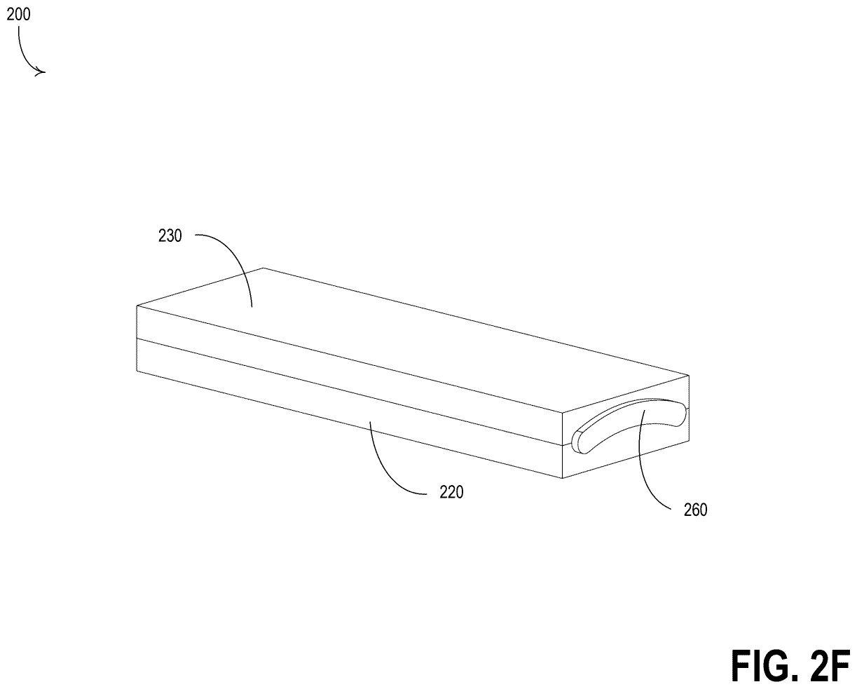

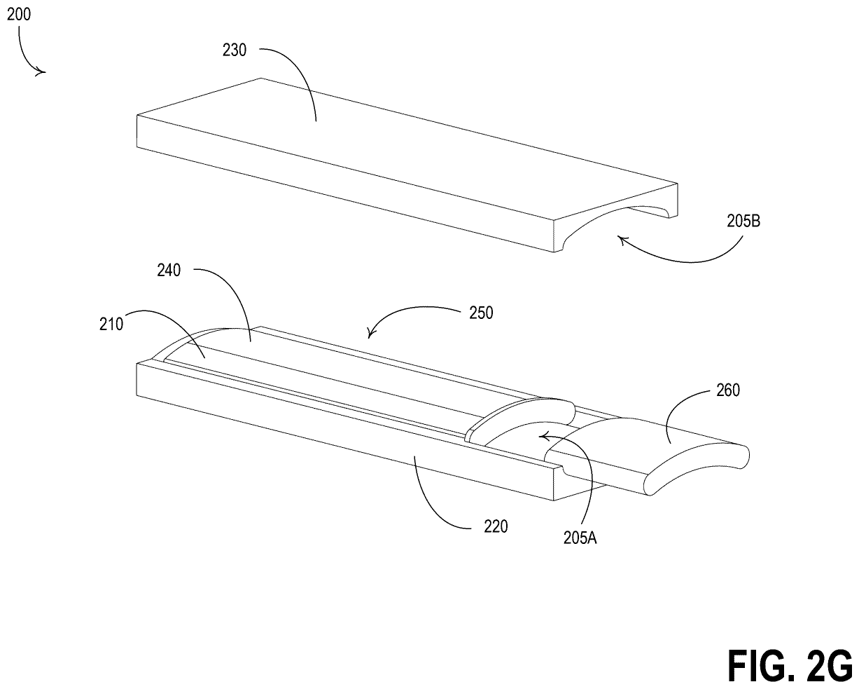

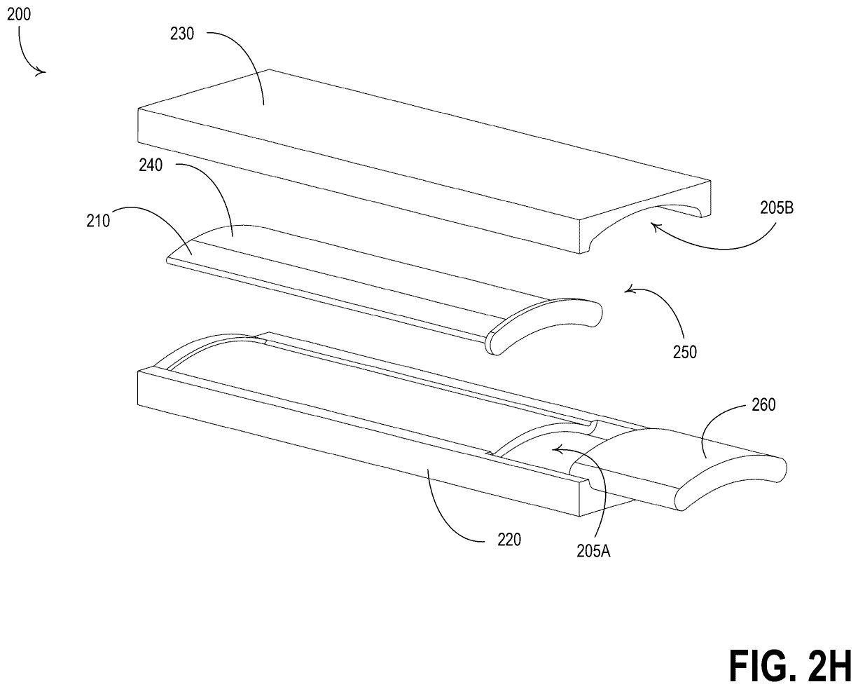

FIGS. 2A-2H are perspective views of an example mold assembly 200 used to produce one or more of the thermoplastic composite foils of FIGS. 1A-1G. As shown in FIGS. 2A-2H, a metallic leading edge 210 (e.g., such as the first portion 110A, 110B, 110C, 110D, 110E, 110F, and/or 110G shown in FIGS. 1A-1G.) may be configured to be installed within and/or aligned within the mold assembly. The mold assembly 200 (e.g., a compression molding tool) may be configured to minimize takt. For example, the mold assembly 200 may be configured such that the takt time and/or processing time is minimized such that a faster takt time and/or processing time may be achieved than adhesively bonding a metallic leading edge 210 onto a composite portion. The metallic leading edge 210 may be produced via 3D printing, for example, to produce the geometry of the metallic leading edge 210 as efficiently as possible while maintaining precise enough geometry at the best possible price. It should be appreciated that production of the metallic leading edge 210 is not limited to 3D printing, for example, the metallic leading edge 210 may be produced via sintering, machining, casting, forging, stamping, deep drawing, injection, or some other suitable process. The metallic leading edge 210 may be surface treated using one or more of a mechanical treatment, a chemical treatment, plasma etching, electro-chemical etching, laser ablation, chemical vapor deposition (CVD), physical vapor deposition (PVD), high velocity oxygen fuel (HVOF) coating, various coatings, zinc plating, copper plating, tinning, or another process of changing the surface topology, chemistry, and/or roughness of the metallic leading edge 210.

The mold assembly 200 may include one or more mold portions. As shown, the mold assembly 200 may include a first mold portion 220 and a second mold portion 230. The mold assembly 200 may define a cavity 205, for example, between the first mold portion 220 and the second mold portion 230. For example, the first mold portion 220 may define a first cavity portion 205A and the second mold portion 230 may define a second cavity portion 205B.

When the metallic leading edge 210 is aligned within the first mold portion 220, an unmolded composite material 215 may be provided to (e.g., inserted into) the mold assembly 200 (e.g., the cavity 205). The mold assembly 200 may include a piston 260. The piston 260 may be configured to be heated and/or inserted into the cavity 205 such that the unmolded composite material 215 fills a volume defined between the cavity 205 and the metallic leading edge 210. The piston 260 may press on the unmolded composite material 215 to move the unmolded composite material 215 into the correct position in the mold assembly 200 (e.g., within the first mold portion 220 and the second mold portion 230).

The mold assembly 200 is then cooled down sufficiently to consolidate (e.g., fully consolidate) the metallic leading edge 210 and the composite material 240 into a thermoplastic composite foil 250. The mold assembly 200 is then opened and the thermoplastic composite foil 250 is removed from the mold assembly 200.

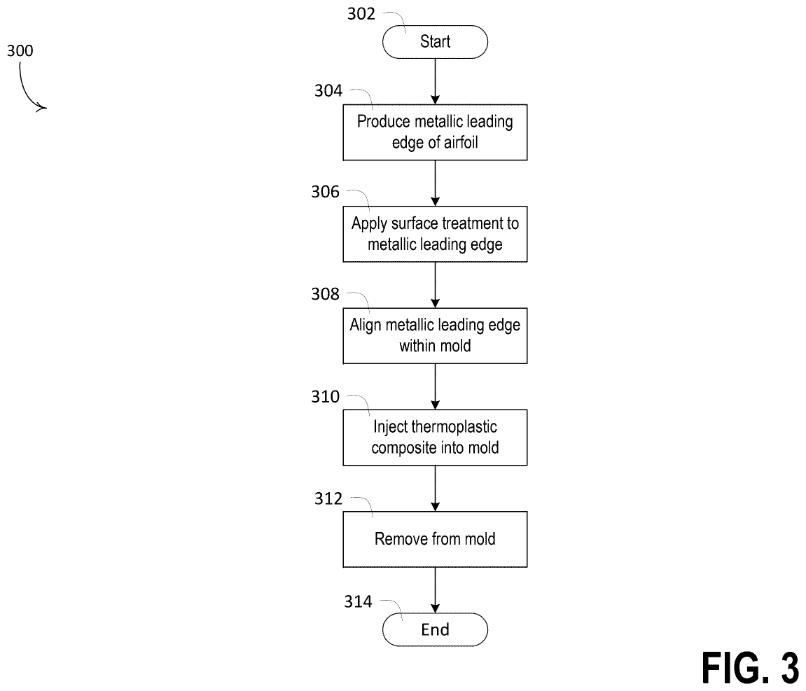

FIG. 3 is a flowchart of an example method 300 of manufacturing a thermoplastic composite foil having a metallic leading edge. The method 300 may enable production of a foil made from thermoplastic composites that can withstand high velocity hail impact resistance testing. The method 300 may enable a reduction in weight in a turbofan engine which may increase range and/or increase fuel efficiency.

The method 300 may start, at 302. At 304, a metallic leading edge (e.g., such as the first portions 110A-110G shown in FIGS. 1A-1G and/or the metallic leading edge 210 shown in FIGS. 2A-2H) of a foil may be produced (e.g., manufactured). The metallic leading edge of the foil may be produced via a 3D printing process, an injection molding process, a casting process, a sintering process, a machining process, a casting process, a forging process, a stamping process, a deep drawing process, an injection process, and/or some other suitable process. The metallic leading edge may be produced with one or more features described herein that improve adhesion between the metallic leading edge and a thermoplastic composite. The metallic leading edge may define a co-molded surface that is surface-treated and configured to abut the thermoplastic composite. The co-molded surface may extend between a first trailing edge of the metallic leading edge and a second trailing edge of the metallic leading edge on an opposite side of the metallic leading edge than the leading edge.

At 306, a surface treatment may be applied to the metallic leading edge. For example, the surface treatment may include one or more of a mechanical treatment, a chemical treatment, plasma etching, electro-chemical etching, laser ablation, chemical vapor deposition (CVD), physical vapor deposition (PVD), high velocity oxygen fuel (HVOF) coating, various coatings, zinc plating, copper plating, tinning, or another process of changing the surface topology, chemistry, and/or roughness of the metallic leading edge.

At 308 the metallic leading edge may be inserted into a mold (e.g., such as the mold assembly 200 shown in FIGS. 2A-2H). For example, the metallic leading edge may be aligned within a cavity of the mold such that one or more edges of the metallic leading edge abut internal surfaces of the mold. Two or more portions of the mold may be secured together with the metallic leading edge within the cavity defined by the two or more portions.

At 310, a thermoplastic composite may be co-molded with the metallic leading edge within the mold assembly. For example, the thermoplastic composite may be introduced into the cavity of the mold assembly. Introducing thermoplastic composites to a mold is described in greater detail in U.S. Pat. No. 10,160,146, filed on Aug. 12, 2011, and issued on Dec. 25, 2018, entitled THERMOPLASTIC FIBER COMPOSITES HAVING HIGH VOLUME FIBER LOADING AND METHODS AND APPARATUS FOR MAKING SAME, the entire disclosure of which is hereby incorporated by reference. The thermoplastic composite may include one or more of the thermoplastic polymers described herein. It should be appreciated that the thermoplastic composite may be added to the mold before the mold is closed. For example, the thermoplastic composite may be added to the mold and then heated (e.g., under pressure) when the mold has been closed. A piston (e.g., such as piston 260 shown in FIGS. 2C and 2E-2H) may be used to apply the pressure within the mold. It should be appreciated that alternative methods (e.g., such as air pressure) may be used to apply the pressure within the mold. If the mold was heated, the mold may be allowed to cool. The mold may then be opened. For example, the one or more portions of the mold may be separated.

At 312, the thermoplastic composite foil with a co-molded metallic leading edge may be removed from the mold. The method 300, may end, at 314.

1. A thermoplastic composite foil comprising:
a first portion that defines a leading edge of the thermoplastic composite foil, the first portion being metallic and defining a co-molded surface on an opposite side of the first portion than the leading edge, wherein the co-molded surface extends between a first trailing edge of the first portion and a second trailing edge of the first portion; and
a second portion that defines a trailing edge of the thermoplastic composite foil, the second portion comprising a thermoplastic composite;
wherein the co-molded surface is surface-treated and configured to abut the second portion, and
wherein the first portion is co-molded with the second portion within a mold assembly.

2. The thermoplastic composite foil of claim 1, wherein the first portion defines a cavity that is configured to receive a portion of the second portion.

3. The thermoplastic composite foil of claim 2, wherein the first portion defines a first outer wall and a second outer wall that defines the cavity.

4. The thermoplastic composite foil of claim 3, wherein the second portion defines a tab that is configured to be received within the cavity such that the tab abuts respective inner surfaces of the first outer wall and the second outer wall.

5. The thermoplastic composite foil of claim 3, wherein the first portion defines a plurality of openings through one or more of the first outer wall or the second outer wall.

6. The thermoplastic composite foil of claim 5, wherein the second portion extends into the plurality of openings.

7. The thermoplastic composite foil of claim 6, wherein the first portion and the second portion are interlocked by the second portion extending into the plurality of openings.

8. The thermoplastic composite foil of claim 5, wherein the plurality of openings is configured to enable a stiffness reduction at an intersection between the first portion and the second portion.

9. The thermoplastic composite foil of claim 8, wherein the plurality of openings is more dense proximate to the first trailing edge and the second trailing edge than distal from the first trailing edge and the second trailing edge.

10. The thermoplastic composite foil of claim 5, wherein the plurality of openings increases in size toward the first trailing edge and the second trailing edge.

11. The thermoplastic composite foil of claim 1, wherein the first trailing edge and the second trailing edge are non-linear.

12. The thermoplastic composite foil of claim 11, wherein the first trailing edge and the second trailing edge are wavy or jagged.

13. A method of manufacturing a thermoplastic composite foil with a metallic leading edge, the method comprising:
producing a metallic leading edge portion of the thermoplastic composite foil with the metallic leading edge;
surface treating the metallic leading edge portion;
placing and aligning the metallic leading edge portion within a mold assembly;
securing two or more portions of the mold assembly with the metallic leading edge portion located within a cavity defined by the two or more portions;
co-molding a thermoplastic composite with the metallic leading edge portion by:
introducing the thermoplastic composite into the cavity; and
applying heat and pressure to the cavity of the mold assembly; and
removing the thermoplastic composite foil with the metallic leading edge from the cavity.

14. The method of claim 13, wherein the metallic leading edge portion defines a plurality of openings through one or more of a first outer wall or a second outer wall.

15. The method of claim 14, wherein the thermoplastic composite extends into the plurality of openings.

16. The method of claim 14, wherein the metallic leading edge portion and the thermoplastic composite are interlocked by the thermoplastic composite extending into the plurality of openings.

17. The method of claim 14, wherein the plurality of openings is configured to enable a stiffness reduction at an intersection between the metallic leading edge portion and the thermoplastic composite.

18. The method of claim 17, wherein the plurality of openings is more dense proximate to a first trailing edge and a second trailing edge of the metallic leading edge portion than distal from the first trailing edge and the second trailing edge.

19. The method of claim 15, wherein the plurality of openings increases in size toward the first trailing edge and the second trailing edge.

20. The method of claim 13, wherein a trailing edge of the metallic leading edge portion is non-linear.
